(19) United States
(12) Patent Application Publication
(10) Pub. No.: US 2004/0219846 A1
(43) Pub. Date: Nov. 4, 2004

(54) Composite biasable reflective sheet and sleeve

(75) Inventors: Timothy D. Sellis, West Grove, PA (US); Harry F. Gladfelter, Kimberton, PA (US); Samuel B. Fryberger JR., Spring City, PA (US)

Correspondence Address: SYNNESTVEDT & LECHNER, LLP, 2600 ARAMARK TOWER, 1101 MARKET STREET, PHILADELPHIA, PA, 191072950

(73) Assignee: Federal-Mogul World Wide, Inc., Southfield, MI

(21) Appl. No.: 10/789,095

(22) Filed: Feb. 27, 2004

Related U.S. Application Data
(60) Provisional application No. 60/467,081, filed on May 1, 2003.

(51) Int. Cl. B32B 27/02; B32B 27/12; B32B 5/02; B32B 27/04

(52) U.S. Cl. 442/46; 442/35; 442/31; 442/38; 442/43; 442/45; 442/47; 442/49; 442/151; 442/320; 442/324; 442/326

(57) ABSTRACT

A composite sheet biasable into a tubular shape to form a sleeve for isolating or protecting elongated items is disclosed. The sheet has a reflective surface formed by a metal foil layer overlying a flexible polymer layer having a metalized surface. A biasable polymer netting layer is positioned overlying the flexible layer opposite the metalized surface. The netting layer is formed of elongated members that define interstices. A damping layer of non-woven material is positioned adjacent to the netting layer. An adhesive layer is positioned between the flexible layer and the netting layer to bond the netting layer and the damping layer to the flexible layer. Biasing is effected by the elongated members of the netting layer which are stiffer in the circumferential direction around the sleeve to provide radial stiffness.

### FIELD OF THE INVENTION

This invention concerns sheet and sleeving for encasing and protecting or isolating elongated items, such as wiring harnesses, fuel lines, brake lines, optical fibers and like objects, which are subjected to harsh physical environments.

### BACKGROUND OF THE INVENTION

Elongated items, such as wiring harnesses, fluid conduits, such as brake lines and fuel lines and optical fiber bundles, are often used in automotive, aerospace, marine and communication applications where they are subjected to the effects of harsh physical environments such as intense heat, vibration, physical impact, shock and abrasion.

Wiring harnesses and fuel lines routed through an enclosed engine compartment, for example, in an automobile, boat or aircraft, are subjected to prolonged and intense vibration as well as both radiant and convective heat from the engine, particularly the exhaust manifold. Similarly, fuel lines and wiring in the vicinity of a rocket engine nozzle or on an orbiting satellite are exposed to severe vibratory acoustical environments upon launch, as well as severe thermal environments when exposed to direct sunlight in the vacuum of space.

Even when subjected only to physical handling, it is advantageous to provide relatively delicate, elongated items such as optical fibers with an external sleeve which supports and protects them from physical damage, as well as excessive bending, pinching and kinking. Protection is necessary because the fibers are generally subject to physical damage due to impact, shock, abrasion, bending and kinking which can result from rough handling during installation, as well as conditions of service. Such environments can impose stress fields within the fibers which adversely affect the transmission of optical signals. Support and protection of the fibers prevents or mitigates excessive, damaging stresses on them by limiting the radius of curvature which the optical fibers will experience; presenting a shield preventing pinching of the fibers between sharp edges, damping shock and vibratory disturbances; providing a preferred load path which relieves the optical fibers of any tensile or compressive loads; and preventing abrasive contact with the optical fiber bundle.

Protective sheet material and sleeving for elongated items should be economical to produce, easy to incorporate into an existing layout or design, provide adequate protection against the expected environmental hazards and be flexible so as to follow the path of the item, yet not too flexible so as to prevent excessive bending and/or kinking of the item. The sleeving should also be robust and able to withstand the harsh environments without significant degradation over extended periods of exposure.

### SUMMARY OF THE INVENTION

The invention concerns a composite sheet capable of reflecting radiant energy. The sheet comprises a reflective layer having a reflective surface and an opposite surface. A netting layer overlies the opposite surface of the reflective layer. The netting layer comprises a plurality of first elongated members positioned in spaced apart relation to one another and a plurality of second elongated members oriented angularly to the first elongated members and positioned in spaced apart relation to one another. The first and second elongated members define a plurality of interstices in the netting layer. The netting layer is biasable in at least one direction to allow the sheet to be formed into various shapes. A damping layer overlies the netting layer.

An adhesive layer is positioned between the netting layer and one of the opposite surface of the reflective layer and the damping layer. The adhesive layer extends through the interstices and bonds the damping layer and the netting layer to the opposite surface of the reflective layer.

Preferably, the reflective layer comprises a flexible, resilient first layer having first and second surfaces oppositely disposed. A metalized film layer overlies the first surface of the first layer. A metal foil layer overlies the metalized film layer. The metal foil layer comprises the reflective surface, the second surface comprises the opposite surface of the reflective layer.

The invention also concerns a composite sleeve for receiving elongated items. The sleeve comprises a sidewall surrounding and defining a central space for receiving the elongated items. The sidewall has a reflective surface and an opposite surface. A netting layer overlies the opposite surface of the sidewall. The netting layer comprises a plurality of first elongated members positioned in spaced apart relation to one another and a plurality of second elongated members oriented angularly to the first elongated members and positioned in spaced apart relation to one another. The first and second elongated members define a plurality of interstices in the netting layer. The netting layer is biasable in at least one direction to maintain the sleeve in a tubular shape. A damping layer overlies the netting layer.

Preferably, the sidewall comprises a flexible resilient first layer having first and second surfaces oppositely disposed. A metalized film layer overlies the first surface of the first layer. A metal foil layer overlies the metalized film layer. The metal foil layer comprises the reflective surface, and the second surface comprises the opposite surface of the sidewall.

The sleeve further comprises an adhesive layer positioned between the netting layer and one of the opposite surfaces of the sidewall and the damping layer. The adhesive layer extends through the interstices and bonds the damping layer and the netting layer to the opposite surface of the sidewall.

### BRIEF DESCRIPTION OF THE DRAWINGS

FIG. 1 is a perspective view of a sleeve according to the invention;

FIG. 2 is an exploded perspective view of a sheet according to the invention;

FIG. 3 is a cross-sectional view taken at line 3-3 of FIG. 1;

FIG. 4 is an exploded perspective view of another embodiment of a sheet according to the invention;

FIG. 5 is a cross-sectional view of an alternate embodiment of a sleeve according to the invention;

FIG. 6 is an exploded perspective view of another embodiment of a sheet according to the invention;

FIG. 7 is a cross-sectional view of another embodiment of a sleeve according to the invention;

FIG. 8 is an exploded perspective view of another embodiment of a sheet according to the invention; and

FIG. 9 is a cross-sectional view of another embodiment of a sleeve according to the invention.

### DETAILED DESCRIPTION OF THE EMBODIMENTS

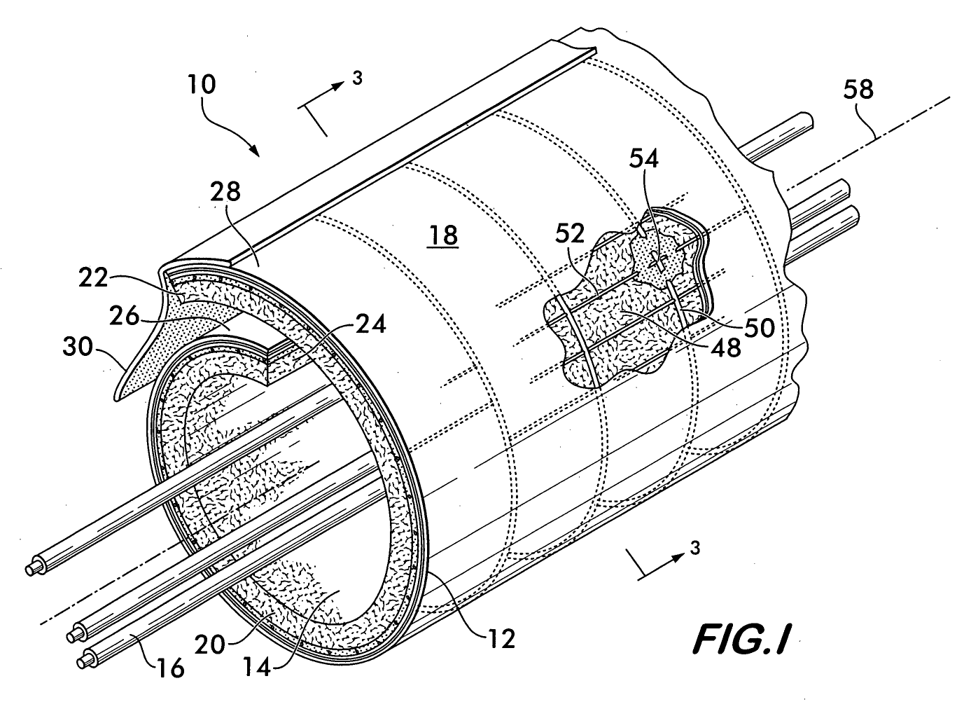

FIG. 1 shows a composite biasable reflective sleeve 10 according to the invention. Sleeve 10 has a sidewall 12 biased into a tubular shape, preferably round in cross section, the sidewall 12 defining a central space 14 for receiving elongated items 16. Sleeve 10 has a reflective surface 18, preferably facing outwardly away from central space 14, and a damping layer 20 forming an inner most layer adjacent to the central space 14. When facing outwardly, the reflective surface 18 protects the items 16 from incident radiant heat. However, if the sleeve 10 is configured so that reflective surface 18 faces inwardly, the sleeve will serve to isolate the items 16 from the ambient. Such a configuration would be useful if, for example, the items 16 were a heat source, such as an exhaust manifold, to be isolated from other components. The damping layer 20 serves to protect the items 16 from vibrational energy, for example, acoustical energy or structure-borne noise.

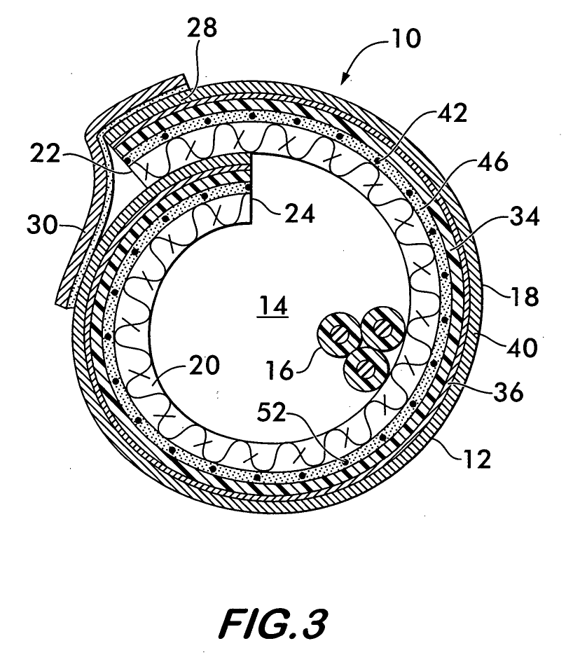

The sidewall 12 has first and second edges 22 and 24 that are oriented substantially lengthwise along sleeve 12 and preferably extend over its entire length. Edges 22 and 24 define an opening 26 that provides access to central space 14. Opening 26 allows sleeve 10 to be positioned over items 16 whose ends are inaccessible, and also allows for convenient splicing and break-out of the items to form branching junctions or to effect repairs. Preferably, the sidewall 12 is biased so that a portion 28 of sidewall 12 is positioned overlying one of the edges 24, in effect closing the opening 26. This allows the sleeve 10 to be substantially self-closing, as the sidewall is resilient and tends therefore to return to the biased configuration in the absence of applied forces that would separate the edges 22 and 24 and expose the central space 14. A self-closing sleeve preferably has no separate means for closing opening 26, but such means may still be used on sleeve 10 to provide added security. Closing means are illustrated in FIGS. 1 and 3 in the form of adhesive tape 30, preferably a reflective tape, positioned along one edge 22 and adherable to the sidewall 10 to close the opening 26. If closing means are used tape 30 is preferred because it is inexpensive and does not significantly affect the bulk or flexibility of the sleeve 10. Other closing means are of course feasible, for example, hook and loop fasteners, buttons, zippers, sutures and the like.

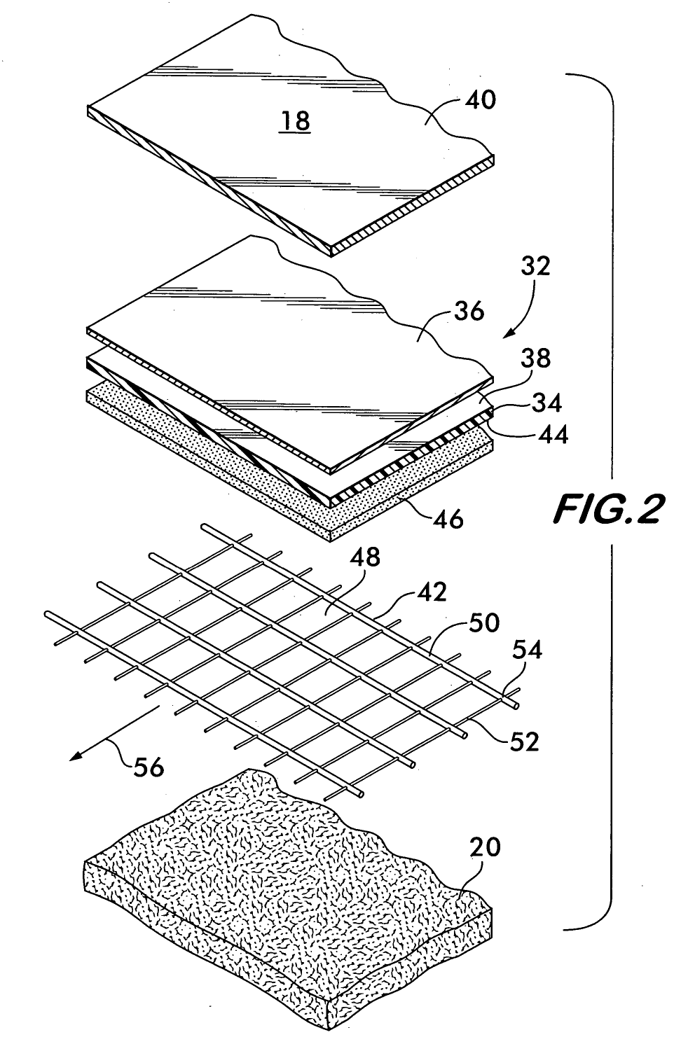

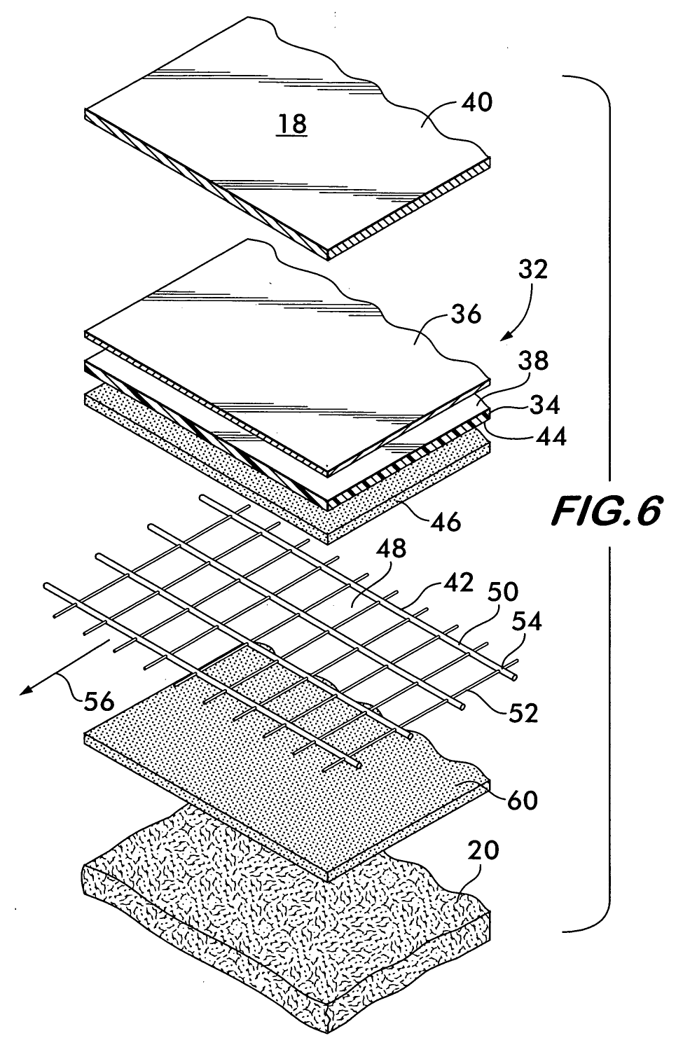

Sleeve 10 may be conveniently formed from a composite reflective sheet 32, shown in an exploded view in FIG. 2. Sheet 32 has a flexible, resilient layer 34 that has a metalized layer 36 applied to one surface 38. A metal foil layer 40 is preferably positioned overlying the metalized layer 36. Foil layer 40 comprises the reflective surface 18 of the sleeve 10. A netting layer 42 is positioned overlying an opposite surface 44 of the layer 34. The netting layer, described in detail below along with the other layers, is resiliently biasable and enables the sheet to be formed into shapes such as the tube shown in FIGS. 1 and 3. The damping layer 20 is positioned overlying the netting layer 42. An adhesive layer 46 is preferably positioned between the netting layer 42 and the layer 34. The netting layer 42 has large interstices 48 that allow the adhesive layer 46 to extend through the netting layer and attach both the netting layer 42 and the damping layer 20 to the layer 34. Adhesive layer 46 could also be positioned between the damping layer 20 and the netting layer 42 (see FIG. 6).

Foil layer 40 preferably comprises aluminum and ranges in thickness between about 0.0002 inches to about 0.002 inches. Other reflective metals are also feasible, for example, gold, which has a high reflectivity, is malleable and flexible when formed into a foil.

Flexible, resilient layer 34 is preferably a polymer such as polyethylene terephthalate which is tough, flexible and able to bond readily with the metalized layer 36. Layer 34 may have a thickness between about 0.00025 inches and about 0.0015 inches with 0.0005 inches being preferred. Metalized layer 36 preferably comprises aluminum that is deposited onto layer 34 by vapor-deposition or sputter techniques to form a metal film between about 10 angstroms and about 200 angstroms in thickness. Foil layer 40 may be adhesively bonded to the metalized layer 36. Placing the metalized layer 36 behind the foil layer 40 provides advantages in the event that the foil layer, which forms the heat reflective surface of both the sheet 32 and the sleeve 10, cracks. Cracks tend to form in the foil layer due to metal fatigue caused by thermal cycling, vibration induced stress and other sources of stress on the foil layer. With the metalized layer 36 behind it, cracks which form in the foil layer will not be readily visible, and incident radiant heat will be reflected from the metalized layer exposed beneath the crack. This is energy that would otherwise enter the central space 14 and adversely affect items 16 therein in the absence of the metalized layer.

Damping layer 20 is preferably a non-woven fibrous material, such as polyester felt, and preferably ranges in thickness from between about 0.03 inches to about 0.1 inches. Non-woven materials are preferred damping materials because of their ability to dissipate vibrational energy, but other materials, such as visco-elastic polymers, are also feasible.

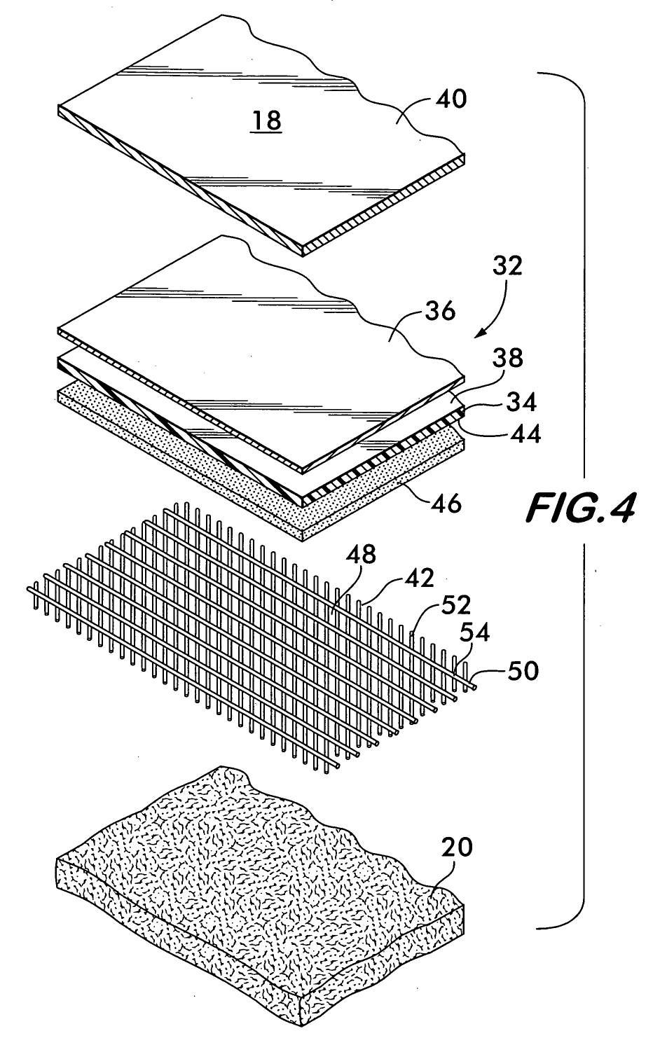

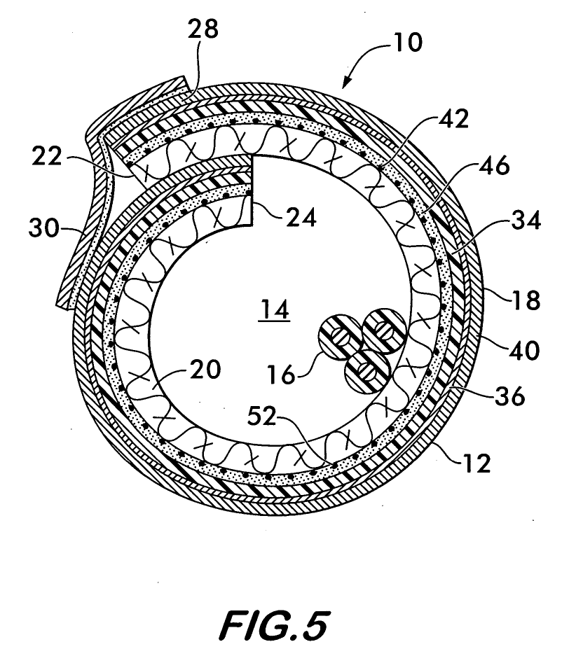

As best illustrated in FIG. 2, netting layer 42 is formed from a plurality of first elongated members 50 arranged in spaced apart relation from one another. First elongated member 50 are attached to a plurality of second elongated members 52 at cross over points 54. The second elongated members 52 are also positioned in spaced apart relation to one another and are angularly oriented with respect to the first elongated members 50. The first and second members 50 and 52 are preferably oriented at about 90 degrees to one another, however, other angular orientations are also feasible, as shown in FIGS. 4 and 5. Although it is preferred that the elongated members in each group be arranged substantially parallel to each other, other arrangements are also feasible. For example, elongated members 50 could be angularly positioned relative to one another, and extend radially from a common center, while elongated members 52 could be arranged circumferentially around the common center.

With reference again to FIG. 2, it is preferred that one group of the elongated members, for example, first elongated members 50, have greater bending stiffness than the other group elongated members, namely, second elongated members 52. The greater stiffness may be attained, for example, by the first elongated members having a greater area moment of inertia than the second elongated members, or being formed from a stiffer material. The netting layer thus may be considered to be formed from a group of relatively stiff elongated members 50 held in spaced apart relation by relatively less stiff elongated members 52, the elongated members 50 and 52 cooperating to define the interstices 48. This stiffness relation between the elongated members allows the netting layer 42 to be biasable in at least one direction while maintaining significant flexibility in another direction as described in detail below.

Preferably, netting layer 42 is comprised of a thermoplastic polymer such as polyester, polypropylene, polyethylene or nylon and is formed in an extrusion process in a continuous web. It is advantageous that the netting 42 be formed such that the long direction, or the direction of manufacture, runs substantially perpendicular to the stiffer elongated members 50 as indicated by arrow 56 in FIG. 2. This configuration allows the netting layer 42 to be easily biased into a tubular form during manufacture to form sleeve 10 with the stiffer elongated members 50 extending circumferentially around the sleeve, and the less stiff elongated members 52 extending substantially lengthwise along the sleeve as shown in FIGS. 1 and 3. The netting layer 42 is thus biasable in a direction substantially perpendicular to the stiffer elongated members 50. Orienting the biased elongated members 50 circumferentially around sleeve 10 increases the radial stiffness of sleeve 10, preventing it from collapsing under applied loads. This arrangement also makes the sleeve substantially self closing, as the netting layer 42 is resilient, and the dominant stiffness, provided by elongated members 50, is such that the sleeve 10 will tend to assume the tubular shape in which the elongated members 50 are biased.

The less stiff elongated members 52 preferably extend lengthwise along the sleeve 10. Being less stiff, they allow the sleeve to bend about its long axis 58 to follow the path of elongated items 16.

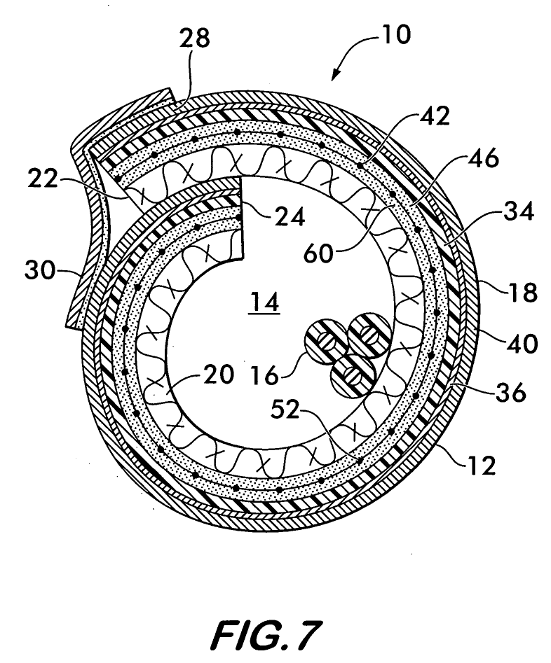

Adhesive layer 46 is preferably an acrylic, pressure sensitive adhesive as it provides a relatively strong bond but does not adversely affect the stiffness of sleeve 10 as other adhesives might. Adhesive layer 46 may range in thickness between 0.0005 inches and 0.0035 inches, 0.001 to 0.002 being preferred for many practical applications. Preferably, only one adhesive layer 46 is used to adhere both the netting layer 42 and the damping layer 20 to the flexible layer 34. This is possible because the adhesive layer 46 extends partially through the interstices 48 of netting layer 42 to engage the damping layer 20. Although it is preferred to position the adhesive layer 46 between netting layer 42 and flexible layer 34, it is also feasible to position an adhesive layer 60 between the damping layer 20 and the netting layer 42 as shown in FIGS. 6 and 7. Adhesive layer 60 may be used alone or in conjunction with adhesive layer 46.

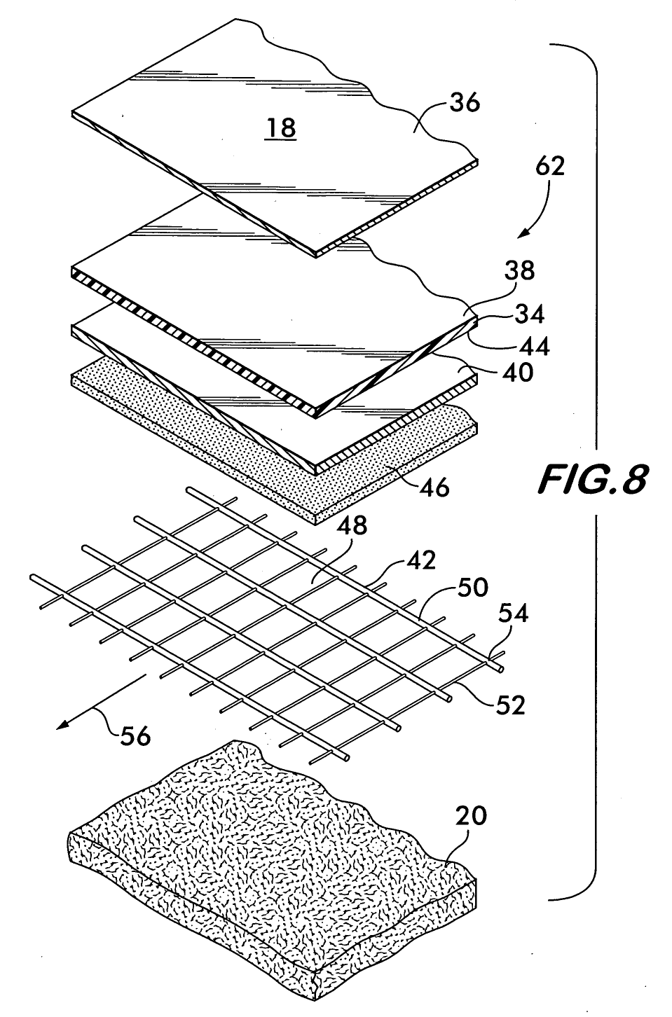

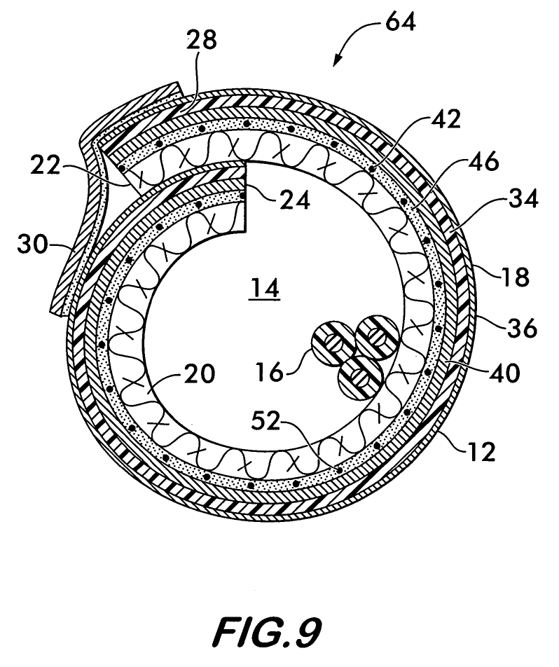

FIGS. 8 and 9 illustrate an alternate embodiment of the sheet 62 and the sleeve 64 according to the invention wherein the metalized layer 36 forms the reflective surface 18 of both the sheet 62 and sleeve 64. In this embodiment, the foil layer 40 is positioned on the surface 44 opposite the metalized layer 36. This embodiment may advantageously be used in lower temperature applications, whereas the previously described embodiment is best employed for relatively higher temperature environments.

Composite biasable reflective sheets and sleeves according to the invention provide a versatile, robust and inexpensive product for the protection or isolation of elongated items from harsh environments of radiant heat and vibration.

What is claimed is:

1. A composite sheet capable of reflecting radiant energy, said sheet comprising:
a reflective layer having a reflective surface and an opposite surface;
a netting layer overlying said opposite surface of said reflective layer, said netting layer comprising a plurality of first elongated members positioned in spaced apart relation to one another and a plurality of second elongated members oriented angularly to said first elongated members and positioned in spaced apart relation to one another, said first and second elongated members defining a plurality of interstices in said netting layer, said netting layer being biasable in at least one direction; and
a damping layer overlying said netting layer.

2. A composite sheet according to claim 1, wherein said reflective layer comprises:
a flexible resilient first layer having first and second surfaces oppositely disposed;
a metalized film layer overlying said first surface of said first layer; and
a metal foil layer overlying said metalized film layer, said metal foil layer comprising said reflective surface, said second surface comprising said opposite surface of said reflective layer.

3. A composite sheet according to claim 1, further comprising an adhesive layer positioned between said netting layer and one of said reflective layer and said damping layer, said adhesive layer extending through said interstices and bonding said damping layer and said netting layer to said opposite surface of said reflective layer.

4. A composite sheet according to claim 3, wherein said adhesive layer is positioned between said netting layer and said reflective layer.

5. A composite sheet according to claim 2, wherein said first layer comprises a polymer.

6. A composite sheet according to claim 2, wherein said first layer is comprised of polyethylene terephthalate.

7. A composite sheet according to claim 2, wherein said metal foil layer comprises aluminum.

8. A composite sheet according to claim 7, wherein said metal foil layer is between about 0.0003 to about 0.002 inches thick.

9. A composite sheet according to claim 7, wherein said metalized film layer comprises aluminum.

10. A composite sheet according to claim 9, wherein said metalized film layer is between about 10 to about 200 angstroms thick.

11. A composite sheet according to claim 2, wherein said metal foil layer is adhesively adhered to said metalized film layer.

12. A composite sheet according to claim 1, wherein said first and second elongated members are oriented at right angles to one another.

13. A composite sheet according to claim 1, wherein said first elongated members have a greater bending stiffness than said second elongated members.

14. A composite sheet according to claim 1, wherein said netting layer is comprised of a thermoplastic polymer.

15. A composite sheet according to claim 1, wherein said netting layer is comprised of polypropylene.

16. A composite sheet according to claim 1, wherein said netting layer is comprised of a material selected from the group consisting of polyester, polypropylene, polyethylene and nylon.

17. A composite sheet according to claim 3, wherein said adhesive layer comprises a pressure sensitive adhesive.

18. A composite sheet according to claim 17, wherein said adhesive layer is between about 0.0005 and about 0.0035 inches thick.

19. A composite sheet according to claim 1, wherein said damping layer comprises a non-woven material.

20. A composite sheet according to claim 1, wherein said damping layer comprises polyester felt.

21. A composite sheet according to claim 20, wherein said polyester felt is between about 0.03 and about 0.1 inches thick.

22. A composite sheet according to claim 13, wherein said sheet is resiliently biased into a tube defining a central space.

23. A composite sheet according to claim 22, wherein said reflective surface comprises an outwardly facing surface of said tube.

24. A composite sheet according to claim 22, wherein said first elongated members are oriented substantially perpendicular to an axis extending lengthwise along said tube.

25. A composite sheet capable of reflecting radiant energy, said sheet comprising:
a reflective layer having a reflective surface and an opposite surface;
a netting layer overlying said opposite surface of said reflective layer, said netting layer comprising a plurality of first elongated members positioned in spaced apart relation to one another and a plurality of second elongated members oriented angularly to said first elongated members and positioned in spaced apart relation to one another, said first and second elongated members defining a plurality of interstices in said netting layer;
a damping layer overlying said netting layer; and
an adhesive layer positioned between said netting layer and one of said opposite surface of said reflective layer and said damping layer, said adhesive layer extending through said interstices and bonding said damping layer and said netting layer to said opposite surface of said reflective layer.

26. A composite sheet according to claim 25, wherein said adhesive layer is positioned between said netting layer and said opposite surface of said reflective layer.

27. A composite sheet according to claim 25, wherein said reflective layer comprises:
a flexible resilient first layer having first and second surfaces oppositely disposed;
a metalized film layer overlying said first surface of said first layer; and
a metal foil layer overlying said metalized film layer, said metal foil layer comprising said reflective surface, said second surface comprising said opposite surface of said reflective layer.

28. A composite sheet according to claim 27, wherein said first layer is comprised of polyethylene terephthalate.

29. A composite sheet according to claim 27, wherein said metal foil layer comprises aluminum.

30. A composite sheet according to claim 29, wherein said metalized film layer comprises aluminum.

31. A composite sleeve for receiving elongated items, said sleeve comprising:
a sidewall surrounding and defining a central space for receiving said elongated items, said sidewall having a reflective surface and an opposite surface;
a netting layer overlying said opposite surface of said sidewall, said netting layer comprising a plurality of first elongated members positioned in spaced apart relation to one another and a plurality of second elongated members oriented angularly to said first elongated members and positioned in spaced apart relation to one another, said first and second elongated members defining a plurality of interstices in said netting layer, said netting layer being biasable in at least one direction; and
a damping layer overlying said netting layer.

32. A composite sleeve according to claim 31, wherein said sidewall comprises:
a flexible resilient first layer having first and second surfaces oppositely disposed;
a metalized film layer overlying said first surface of said first layer; and
a metal foil layer overlying said metalized film layer, said metal foil layer comprising said reflective surface, said second surface comprising said opposite surface of said sidewall.

33. A composite sleeve according to claim 31, further comprising an adhesive layer positioned between said netting layer and one of said opposite surface of said sidewall and said damping layer, said adhesive layer extending through said interstices and bonding said damping layer and said netting layer to said opposite surface of said sidewall.

34. A composite sleeve according to claim 33, wherein said adhesive layer is positioned between said netting layer and said opposite surface of said sidewall.

35. A composite sleeve according to claim 31, wherein said reflective surface faces outwardly away from said central space.

36. A composite sleeve according to claim 31, wherein said sidewall comprises first and second edges oriented substantially lengthwise along said sleeve, said edges defining an opening providing access to said central space.

37. A composite sleeve according to claim 36, wherein said sidewall is resiliently biased so that the first edge overlies the second edge.

38. A composite sleeve according to claim 36, further comprising a means for closing said opening mounted on said sidewall along at least one of said edges.

39. A composite sleeve according to claim 32, wherein said first layer is comprised of a polymer.

40. A composite sleeve according to claim 32, wherein said first layer is comprised of polyethylene terephthalate.

41. A composite sleeve according to claim 32, wherein said metal foil layer comprises aluminum.

42. A composite sleeve according to claim 41, wherein said metal foil layer is between about 0.0003 to about 0.002 inches thick.

43. A composite sleeve according to claim 41, wherein said metalized film layer comprises aluminum.

44. A composite sleeve according to claim 43, wherein said metalized film layer is between about 0.0005 to about 0.001 inches thick.

45. A composite sleeve according to claim 31, wherein said first and second elongated members are oriented at right angles to one another.

46. A composite sleeve according to claim 31, wherein said first elongated members have a larger bending stiffness than said second elongated members.

47. A composite sleeve according to claim 46, wherein said first elongated members are oriented substantially perpendicular to an axis extending lengthwise along said sleeve.

48. A composite sleeve according to claim 31, wherein said netting layer is comprised of a thermoplastic polymer.

49. A composite sleeve according to claim 48, wherein said netting layer is comprised of polypropylene.

50. A composite sleeve according to claim 31, wherein said netting layer is comprised of a material selected from the group consisting of polyester, polypropylene, polyethylene and nylon.

51. A composite sleeve according to claim 33, wherein said adhesive layer comprises a pressure sensitive adhesive.

52. A composite sleeve according to claim 51, wherein said adhesive layer is between about 0.0005 and about 0.0035 inches thick.

53. A composite sleeve according to claim 31, wherein said damping layer comprises a non-woven material.

54. A composite sleeve according to claim 31, wherein said damping layer comprises polyester felt.

55. A composite sleeve according to claim 53, wherein said non-woven layer is between about 0.03 and about 0.1 inches thick.

56. A composite sleeve for receiving elongated items, said sleeve comprising:
a sidewall surrounding and defining a central space for receiving said elongated items, said sidewall having a reflective surface and an opposite surface;
a netting layer juxtaposed with said opposite surface of said sidewall, said netting layer comprising a plurality of first elongated members positioned in spaced apart relation to one another and a plurality of second elongated members oriented angularly to said first elongated members and positioned in spaced apart relation to one another, said first and second elongated members defining a plurality of interstices in said netting layer;
a damping layer overlying said netting layer; and
an adhesive applied so as to penetrate said interstices and bond said damping layer and said netting layer to said opposite surface of said sidewall.

57. A composite sleeve according to claim 56, wherein said adhesive is positioned between said netting layer and said opposite surface of said sidewall.

58. A composite sleeve according to claim 56, wherein said sidewall comprises:
a flexible resilient first layer having first and second surfaces oppositely disposed;
a metalized film layer overlying said first surface of said first layer; and
a metal foil layer overlying said metalized film layer, said metal foil layer comprising said reflective surface, said second surface comprising said opposite surface of said sidewall.

59. A composite sleeve according to claim 58, wherein said first layer is comprised of polyethylene terephthalate.

60. A composite sleeve according to claim 58, wherein said metal foil layer comprises aluminum.

61. A composite sleeve according to claim 60, wherein said metalized film layer comprises aluminum.

62. A composite sheet capable of reflecting radiant energy, said sheet comprising:
a flexible resilient first layer having first and second surfaces oppositely disposed;
a metalized film layer overlying said first surface of said first layer;
a metal foil layer overlying said metalized film layer; and
a netting layer overlying said second surface of said first layer, said netting layer comprising a plurality of first elongated members positioned in spaced apart relation to one another and a plurality of second elongated members oriented angularly to said first elongated members and positioned in spaced apart relation to one another, said first and second elongated members defining a plurality of interstices in said netting layer, said netting layer being biasable in at least one direction.

63. A composite sheet according to claim 62, further comprising a flexible damping layer overlying said netting layer.

64. A composite sheet according to claim 63, further comprising an adhesive layer positioned between said netting layer and said second surface of said first layer, said adhesive layer extending through said interstices and bonding said damping layer and said netting layer to said second surface of said first layer.

65. A composite sheet capable of reflecting radiant energy, said sheet comprising:
a flexible resilient first layer having first and second surfaces oppositely disposed;
a metalized film layer overlying said first surface of said first layer;
a metal foil layer overlying said second surface of said first layer; and
a netting layer overlying said metal foil layer, said netting layer comprising a plurality of first elongated members positioned in spaced apart relation to one another and a plurality of second elongated members oriented angularly to said first elongated members and positioned in spaced apart relation to one another, said first and second elongated members defining a plurality of interstices in said netting layer, said netting layer being biasable in at least one direction.

66. A composite sheet according to claim 65, further comprising a damping layer overlying said netting layer.

67. A composite sheet according to claim 66, further comprising an adhesive layer positioned between said netting layer and said metal foil layer, said adhesive layer extending through said interstices and bonding said damping layer and said netting layer to said metal foil layer.
